(19) United States
(12) Patent Application Publication
(10) Pub. No.: US 2008/0022142 A1
(43) Pub. Date: Jan. 24, 2008

(54) Multiprocessor System, Synchronization Control Apparatus and Synchronization Control Method

(76) Inventor: Shinichiro Nishioka, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/664,518

(22) PCT Filed: Oct. 21, 2005
(86) PCT No.: PCT/JP05/19398

§ 371 Date: Apr. 3, 2007

(30) Foreign Application Priority Data
Oct. 27, 2004 (JP) 2004-311760

(51) Int. Cl. G06F 9/52

(52) U.S. Cl. 713/375

(57) ABSTRACT

The object of the present invention is to provide a multiprocessor system that is capable of performing hierarchical parallel processing. The multiprocessor system includes a plurality of element processors and a plurality of synchronization control units respectively corresponding thereto. The synchronization control units are connected together for receiving and transmitting a synchronization signal from and to each other. The synchronization signal is set in accordance with processing to be executed next by one of the element processors that corresponds to each synchronization control unit. Each synchronization control unit comprises a synchronization permission unit operable to output a synchronization permission signal to one of the element processors that corresponds thereto if a synchronization request signal has been input from the one of the element processors and all of synchronization signals selected based on synchronization selection information set by any of the element processors indicate a prescribed value.

### TECHNICAL FIELD

The present invention relates to a multiprocessor system including a plurality of element processors, and particularly to synchronization control among processes respectively performed by the element processors.

### BACKGROUND

In the parallel distributed processing of the multiprocessor system, if it is necessary to maintain the consistency among the processes executed by the processor, relating to reception of data and the processing order, the multiprocessor executes the processes while synchronizing the element processors.

For example, a multiprocessor system disclosed in Patent Document 1 below includes a synchronization control units respectively corresponding to the element processors. Synchronization among processes respectively executed by the element processors is realized by transmission and reception of synchronization signal among the synchronization control units.

FIG. 13 simply illustrates the structure of a multiprocessor system 1500 disclosed by the Patent Document 1.

The multiprocessor system 1500 includes five element processors PE0-PE4, and synchronization control units Z0-Z4 respectively corresponding to the element processors.

The element processors PE0-PE4 are respectively connected with the synchronization control units Z0-Z4 by SYNCREQ signal wires and SYNCACK signal wires as shown in FIG. 13.

The SYNCREQ signal wire is used by the element processor to transmit asserted or deasserted synchronization signals to the corresponding synchronization control unit. The SYNCACK signal wire is used by the synchronization control unit to transmit asserted or deasserted synchronization signals to the corresponding element processor.

The synchronization control units Z0-Z4 are connected with a synchronization bus 1501, and able to transmit and receive asserted or deasserted synchronization signals to and from each other.

The following describes the case where the multiprocessor system 1500 executes hierarchical parallel processing.

FIG. 14 shows hierarchical parallel processing to be executed by the element processors PE0-PE4.

To the element processor PE0, an application in an application layer, a process A in a process layer and a thread A in a thread layer are allocated. To the element processor PE1, the thread B is allocated. To the element processor PE2, a thread C is allocated. To the element processor PE3, a process B and thread D is allocated. To the element processor PE4, a thread E is allocated.

The element processor PE0 that executes the application starts the processing of the process A at a prescribed time, and has the element processor PE3 start the processing of the process B.

The element processor PE0 that executes the thread A starts the processing of the thread A at a prescribed time, and has the element processor PE1 and the element processor PE2 start the processing of the thread B and the thread C respectively.

The element processor PE3 that executes the process B starts the processing of the process D at a prescribed time, and has the element processor PE4 start the processing of thread E.

At a time when the processing of all the threads A, B and C finish, the element processor PE0 that executes the process Performs processing using the processing result of each of the threads A, B and C. At a time when the processing of both threads D and E finish, the element processor PE3 that executes the process B performs processing using the processing result of each of the threads D and E.

At a time when the processing of both processes A and B finish, the element processor PE0 that executes the application performs processing using the processing result of each of the processes.

For example, upon finishing the processing of the thread A, the element processor PE0 asserts the SYNCREQ signal. The corresponding synchronization control unit Z0 asserts the synchronization signal SYNC0 to show that the element processor PE0 is waiting for the synchronization. The synchronization control unit Z0 notifies, via the synchronization bus 1501, the other synchronization control units Z1-Z4 of that the element processor PE0 is waiting for the synchronization.

The element processor PE0 pauses the next processing until the SYNCACK signal is asserted by the synchronization control unit Z0. Upon receiving the asserted synchronization signals from the synchronization control unit Z1 corresponding to the element processor PE1 that executes the processing of the thread B and the synchronization control unit Z2 corresponding to the element processor PE2 that executes the processing of the thread C, the synchronization control unit Z0 transmits an asserted synchronization permission signal that indicates that the waiting for the synchronization is to be cancelled, to the element processor PE0.

Upon receiving the asserted synchronization permission signal from the synchronization control unit Z0, the element processor PE0 starts the processing of the next process A.

Patent Document: Japanese Patent Publication No. 1940586

### DISCLOSURE OF THE INVENTION

Problem to be Solved

The problem is that the element processor PE3 that executes the thread D asserts the SYNCREQ signal when completing the processing of the thread D, and the synchronization control unit Z3 having received the asserted SYNCREQ signal asserts the synchronization signal.

At this moment, if the element processor PE0 has completed the processing of the process A, this means that the element processor PE0 is waiting for the synchronization signal from the synchronization control unit Z3 corresponding to the element processor PE3 that executes the processing of the process B. Therefore, the synchronization control unit Z0 corresponding to the element processor PE0 misidentifies the synchronization signal that is transmitted from the synchronization control unit Z3 when the thread D is completed by the element processor PE3 as the asserted synchronization signal to be transmitted when the process B is completed. As a result, the synchronization control unit Z0 erroneously transmits a synchronization permission signal to the element processor PE0.

In other words, if the multiprocessor system disclosed by the Patent Document 1 above executes hierarchical parallel processing, there is a possibility that the element processors can not synchronize with each other.

The object of the present invention is to provide a multiprocessor system, a synchronization control apparatus and a synchronization control method that realize the aforementioned hierarchical parallel processing.

Means for solving the Problem

To achieve the object above, the present invention provides a multiprocessor system that includes a plurality of element processors and a plurality of synchronization control units respectively corresponding thereto, wherein each of the element processors comprises: a setting unit operable to set, to any of the synchronization control units, a value of a synchronization signal to be transmitted by the any of the synchronization control units and synchronization selection information to be used for selecting any of received synchronization signals, in accordance with processing to be executed next by one of the element processors that corresponds to the any of the synchronization control units; and an output unit operable to output a synchronization request signal to one of the synchronization control units that corresponds thereto before execution of processing that requires synchronization with another one or more of the element processors, to pause the execution of the processing until a synchronization permission signal is input from the one of the synchronization control units, and the synchronization control units are connected together for receiving and transmitting the synchronization signal from and to each other, and each comprises a synchronization permission unit operable to output a synchronization permission signal to one of the element processors that corresponds thereto if the synchronization request signal has been input from the one of the element processors and all of synchronization signals selected based on the synchronization selection information set by the any of the element processors indicate a prescribed value.

The present invention also provides synchronization control apparatuses that are provided in a multiprocessor system and respectively correspond to element processors included in the multiprocessor system, each comprising a transmission unit operable to transmit a synchronization signal indicating a value set by any of the element processors to another one or more of the synchronization control apparatuses; a reception unit operable to receive the synchronization signal from the one or more of the synchronization control apparatuses; and a synchronization permission unit operable to output a synchronization permission signal to one of the element processors that corresponds thereto if a synchronization request signal has been input from the one of the element processors and all of synchronization signals selected based on the synchronization selection in formation set by the any of the element processors indicate a prescribed value.

The present invention also provides a synchronization control method used in a multiprocessor system that includes a plurality of element processors and a plurality of synchronization control units respectively corresponding thereto, comprising: the steps performed by each element processors of setting, to any of the synchronization control units, a value of a synchronization signal to be transmitted by the any of the synchronization control units and synchronization selection information to be used for selecting any of received synchronization signals, in accordance with processing to be executed next by one of the element processors that corresponds to the any of the synchronization control units; and outputting a synchronization request signal to one of the synchronization control units that corresponds thereto before execution of processing that requires synchronization with another one or more of the element processors, to pause the execution of the processing until a synchronization permission signal is input from the one of the synchronization control units, and the step performed by each of the synchronization control units that are connected for receiving and transmitting the synchronization signal from and to each other of outputting a synchronization permission signal to one of the element processors that corresponds thereto if the synchronization request signal has been input from the one of the element processors and all of synchronization signals selected based on the synchronization selection information set by the any of the element processors indicate a prescribed value.

### ADVANTAGEOUS EFFECTS OF THE PRESENT INVENTION

With the multiprocessor system having the stated structure, in the hierarchical parallel processing, it is possible to control the corresponding synchronization control unit not to assert the synchronization signal when the second element processor, which executes the processing of the middle layer after the first element processor completing processing of the layer, completes the lower layer. On the contrary, it is possible to assert the synchronization signal, to provide a setting for notifying the third element processor, which executes the processing of the higher layer, of that the second element processor completes the processing of the middle layer. Therefore, the stated structure can realize a hierarchical parallel processing without causing a problem such as a synchronization error among the element processors.

A multiprocessor system including the synchronization control units having the aforementioned structure and respectively corresponding to the element processors, and a multiprocessor system using the aforementioned synchronization control method also can realize the hierarchical parallel processing in the same manner.

Here, the multiprocessor system may further include a shared memory that is accessible from each of the element processors and each of the synchronization control units, on which are mapped areas for storing synchronization selection information for each of the synchronization control units, wherein each of the synchronization control units may further comprise a synchronization register connected with corresponding one of the element processors by a dedicated line, and each of the element processors may set the value of the synchronization signal to the synchronization register in accordance with the processing to be executed next.

With the stated structure, any of the element processors can previously write the synchronization selection information into the shared memory to set the synchronization selection information for any of the synchronization control units, and previously write the value of the synchronization signal to the synchronization register of the synchronization control unit corresponding to the element processor. Therefore, it is unnecessary for the element processors to continuously output signals for the setting.

For example, while executing the higher layer, the third element processor can previously set the synchronization selection information for the synchronization control unit corresponding to the second element processor that executes the middle layer and the lower layer.

Here, each of the element processors may further comprise an execution unit operable to execute a synchronization instruction including information specifying the synchronization selection information, and the execution unit may cause the output unit to output the synchronization request signal to the corresponding one of the synchronization control units, and may cause the setting unit to set the synchronization selection information to one of the synchronization control units that is specified by the synchronization instruction.

With the stated structure, only one instruction is required to output the synchronization request signal and set the synchronization selection information to the specified synchronization control unit.

Also, the setting unit may further set synchronization mode information for determining the prescribed value to the any of the synchronization control units, and the synchronization permission unit outputs the synchronization permission signal if the synchronization request signal has been input from the one of the element processors and all of the synchronization signals selected based on the synchronization selection information indicate the prescribed value that is determined based on the synchronization mode information.

With use of the synchronization mode information and the synchronization selection information, it is possible to set the synchronization control unit so as to output the synchronization permission signal if the value of the selected synchronization signal becomes the prescribed value.

Here, the multiprocessor system may further include a shared memory that is accessible from each of the element processors and each of the synchronization control units, on which are mapped areas for storing synchronization selection information for each of the synchronization control units, wherein each of the synchronization control units may further comprise a synchronization register connected with corresponding one of the element processors by a dedicated line, and a synchronization mode register, and each of the element processors may set the value of the synchronization signal to the synchronization register in accordance with a value of one of the synchronization signals, and sets the synchronization mode information to the synchronization mode register corresponding thereto.

With the stated structure, any of the element processors can previously write the value of the synchronization signal into the shared memory to set the value of the synchronization signal for any of the synchronization control units, and previously write the value of the synchronization selection information and the synchronization mode information to the synchronization register of the synchronization control unit corresponding to the element processor. Therefore, it is unnecessary for the element processors to continuously output signals for the setting.

Here, each of the element processors may further comprise an execution unit operable to execute a synchronization instruction including information specifying the synchronization selection information and the synchronization mode information, and the execution unit may cause the output unit to output the synchronization request signal to the corresponding one of the synchronization control units, and may cause the setting unit to set the synchronization selection information and the synchronization mode information to one of the synchronization control units that is specified by the synchronization instruction.

With the stated structure, only one instruction is required to output the synchronization request signal and set the synchronization selection information and the synchronization mode information to the specified synchronization control unit.

### BRIEF DESCRIPTION OF THE DRAWINGS

FIG. 1 shows a structure of a multiprocessor system 1;

FIG. 2 shows a structure of a synchronization control unit S0;

FIG. 3 shows a structure of a logical circuit structure of a synchronization permission unit 201;

FIG. 4 is a time chart showing a case where hierarchical parallel processing is executed by a multiprocessor system 1;

FIG. 5 shows a format of a synchronization instruction including a synchronization selection signal field;

FIG. 6 shows a synchronization instruction and a synchronization selection table;

FIG. 7 shows a structure of a synchronization control unit S0X;

FIG. 8 shows a logical circuit structure of a synchronization permission unit 801;

FIG. 9 is a time chart showing a case where hierarchical parallel processing is executed by a multiprocessor system 1X;

FIG. 10 shows a format of a synchronization instruction including a synchronization selection signal field and a synchronization mode bit;

FIG. 11 shows a structure of a synchronization control unit S0Y;

FIG. 12 shows a structure of a synchronization control unit S0Z;

FIG. 13 shows a structure of a conventional multiprocessor system 1500; and

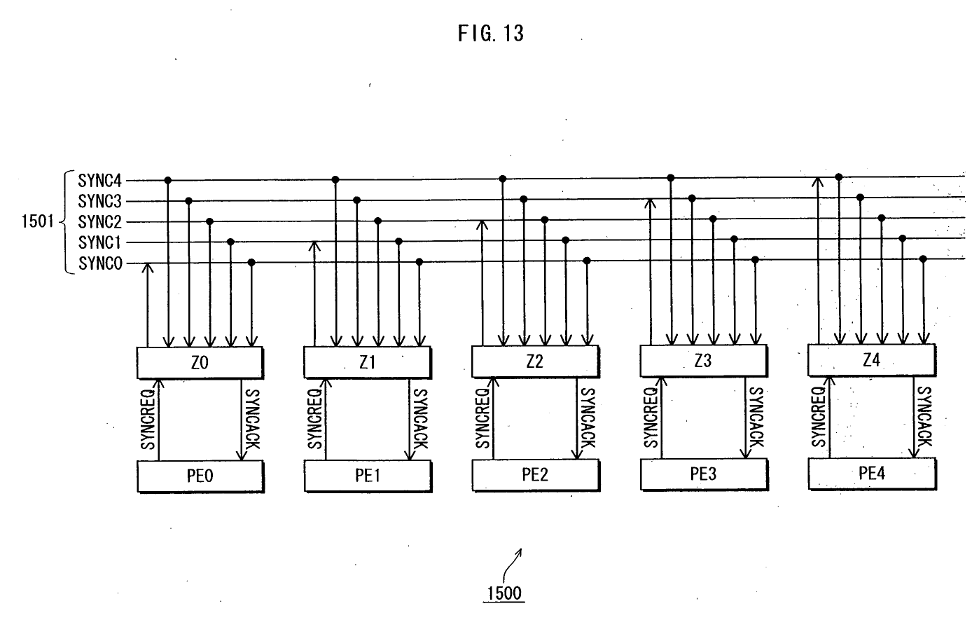

FIG. 14 shows a flow of hierarchical parallel processing executed by each of element processors PE0-PE4.

### EXPLANATION OF REFERENCES

1, 1500 Multiprocessor system

2, 1501 Synchronization bus

3 Shared bus

4 Shared memory

200 Synchronization register

201, 801, 1301, 1401 Synchronization permission unit

800, 1300 Synchronization signal output unit

802 Synchronization selection register

803, 1302 Synchronization mode register

PE0-PE04, PE0X, PE0Y, PE0Z Element processor

S0-S4, S0X, S0Y, S0Z Synchronization control unit

Best Mode for Carrying Out the Invention

The following describes an embodiment of the present invention, with reference to the drawings.

<Structure>

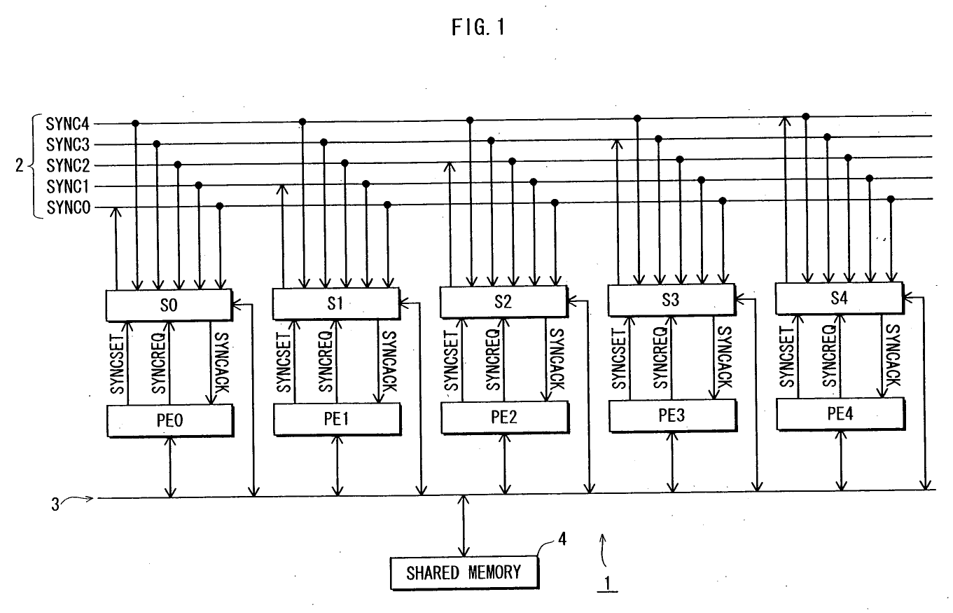

FIG. 1 shows a structure of the multiprocessor system 1.

The multiprocessor system 1 includes five element processors PE0-PE4, synchronization control units S0-S4 respectively corresponding to the element processors PE0-PE4, a synchronization bus 2 with which the synchronization control units S0-S4 are connected, and a shared bus 3 with which the element processors PE0-PE4, the synchronization control units S0-S4 and a shared memory are connected.

The number of signal wires included in the synchronization bus 2 is five, which is the same as the number of the element processors.

Each of the element processors PE0-PE4 and one of the synchronization control units S0-S4 corresponding thereto are connected with each other via a SYNCSET signal wire, a SYNCREQ signal wire and a SYNCACK signal wire.

The shared memory 4 includes areas mapped there to for storing pieces of synchronization selection information for the synchronization control unit S0-S4.

Each of the synchronization selection information is a five-bit binary number, the bits respectively corresponding to synchronization signals SYNC4, SYNC3, SYNC2, SYNC1 and SYNC0 in the order from the highest bit to the lowest bit. Any of the element processors sets the bits by writing them into the shared memory 4.

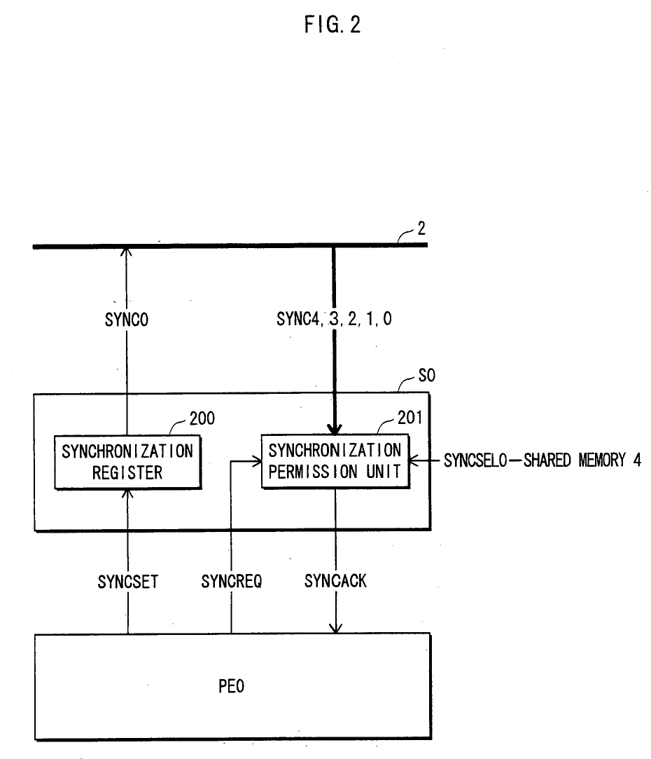

FIG. 2 shows a structure of the synchronization control unit S0 as a representative of the synchronization control units.

Each of the other synchronization control units S1-S4 is connected with different element processor and a different signal wire, but has the same structure as the synchronization control unit S0. Therefore, an explanation thereof is omitted.

The synchronization control unit S0 includes therein a synchronization register 200 and a synchronization permission unit 201.

The synchronization register 200 is connected with the SYNCSET signal wire and the SYNC0 signal wire. The synchronization permission unit 201 is connected with the SYNC0-SYNC4 signal wires (the synchronization bus 2), the shared bus 3, the SYNCREQ signal wire and the SYNCACK signal wire.

The SYNCSET signal wire is a signal wire for transmitting a value set by the element processor PE0 to the synchronization register 200.

If the value stored in the synchronization register 200 is 1, the synchronization control unit S0 asserts and outputs the SYNC0 signal. If the value stored in the synchronization register 200 is 0, the synchronization control unit S0 deasserts and outputs the SYNC0 signal.

The SYNCREQ signal wire is for transmitting a synchronization request signal, which is asserted when the element processor PE0 executes a synchronization request, to the synchronization control unit S0 corresponding to the element processor PE0.

The synchronization permission unit 201 receives the synchronization request signal via the SYNCREQ signal wire, receives the synchronization signals from the synchronization control units via the SYNC0-SYNC4 signal wires, reads the synchronization selection information SYNCSEL0 written in the shared memory 4, via the shared bus 3, and performs logical operations using the received synchronization signals, the synchronization selection information SYNCSEL0 and the synchronization request signal to output a synchronization permission signal of 0 (deassertion) or 1 (assertion) to the element processor PE0 via the SYNCACK signal wire.

Between a time when the synchronization request signal is asserted and a time when the synchronization permission signal is asserted, each of the element processors PE0-PE4 pauses the execution of the processing to wait for the synchronization.

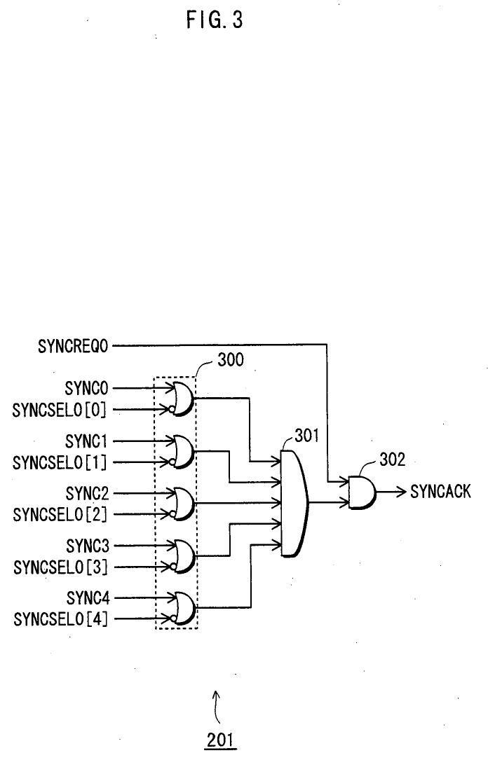

FIG. 3 shows a logical circuit structure of the synchronization permission unit 201.

OR circuit devices included in a portion 300 surrounded by a dotted line in FIG. 3 respectively receive synchronization signals (SYNC0-SYNC4) from the synchronization control units and inverted values of the bits (SYNCSEL[0], SYNCSEL[1] SYNCSEL[2], SYNCSEL[3] and SYNCSEL[4]) of the read synchronization selection information SYNCSEL0.

Then, the results of the logical additions performed by the OR circuit devices are input to a wired AND circuit device 301. The output from the wired AND circuit device 301 and the synchronization request signal are input to an AND circuit device 302. The AND circuit device 302 outputs a result signal to the SYNCACK signal wire.

<Operations>

The following describes specific operations with reference to a time chart.

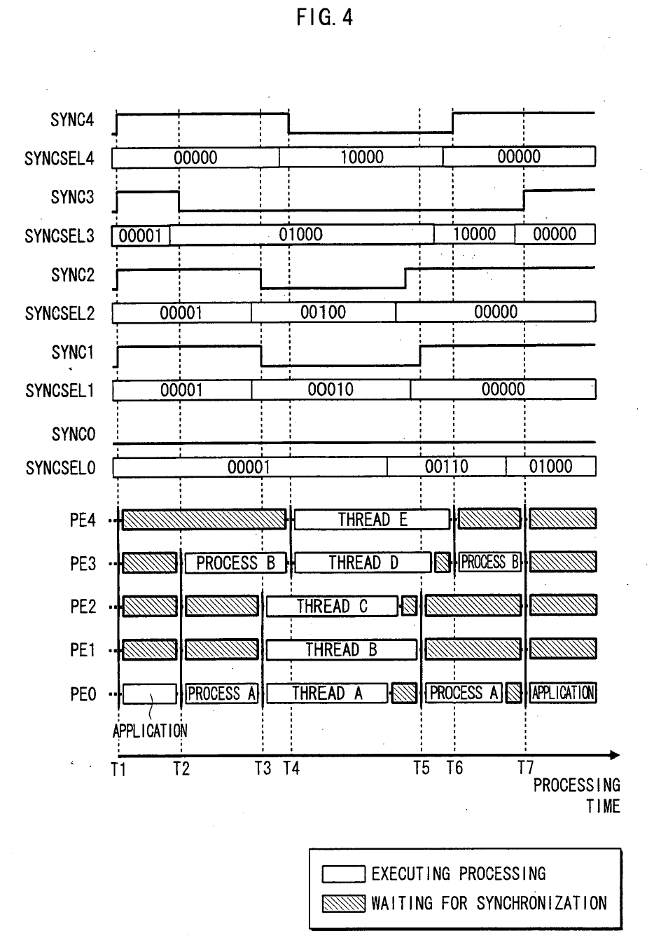

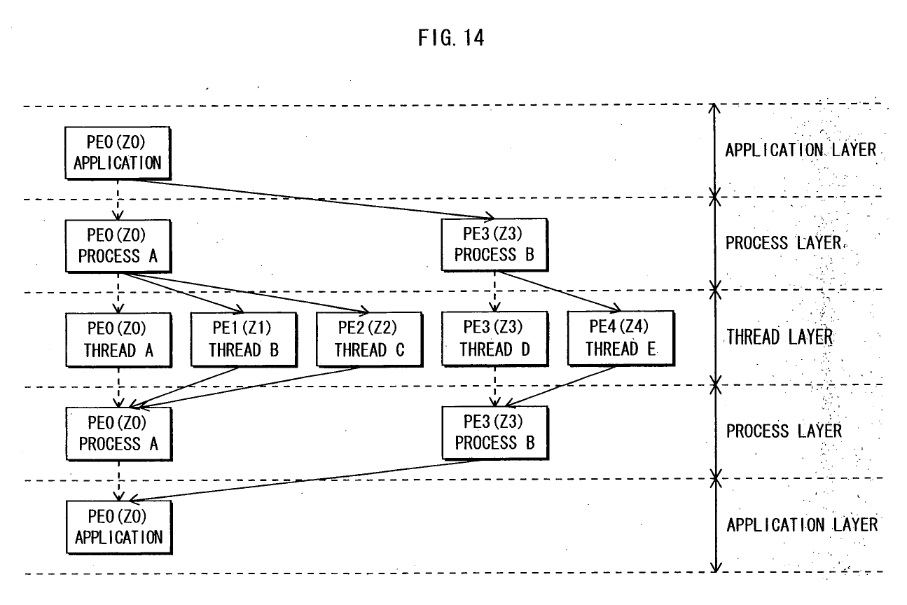

FIG. 4 is a time chart showing the case where the hierarchical parallel processing shown in FIG. 14 is executed by the multiprocessor system 1.

Operations of the element processors PE0-PE4 and the synchronization control units S0-S4 are explained as to each of times T1-T7 shown in FIG. 4.

<Time T1>

The element processor PE0 starts the processing of the application from the time T1, and sets the shared memory 4 such that each of the synchronization selection information SYNCSEL0-SYNCSEL4 becomes “00001”. Since a default value “0” has been set to the synchronization register of the synchronization control unit S0 corresponding to the element processor PE0, the status of the synchronization signal SYNC0 does not change from the “deassertion”.

At the time T1, the element processors PE1-PE4 set a value “1” to the synchronization registers of the corresponding synchronization control units S1-S4 respectively, and assert the synchronization request signals.

Since a value “1” has been set to the synchronization registers of the synchronization control units S1-S4, the synchronization control units S1-S4 respectively assert the synchronization signals SYNC1-4. Also, since each of the synchronization selection information SYNCSEL0-SYNCSEL4 has been set to be “00001” and the synchronization control unit S0 has not asserted the synchronization signal SYNC0, the synchronization control units S1-S4 to which the asserted synchronization request signals are input do not assert the synchronization permission signals.

<Time T2>

Immediately before the time T2, that is, before the process A and the process B start, the element processor PE0 sets the shared memory 4 such that the synchronization selection information SYNCSEL3 becomes “01000”, and starts the processing of the process A.

Since the synchronization control unit S3 corresponding to the element processor PE3 has asserted the synchronization signal SYNC3, and the synchronization selection information SYNCSEL3 has been set as “01000”, and the synchronization request signal from the element processor PE3 has been asserted, the synchronization permission unit of the synchronization control unit S3 asserts the synchronization permission signal. As a result, the element processor PE3 starts the processing of the process B.

Immediately after asserting the synchronization permission signal, the synchronization control unit S3 deasserts the synchronization signal SYNC3.

At the time T2, the element processors PE1, PE2 and PE4 keep waiting for the synchronization.

<Time T3>

Immediately before the time T3, that is, before the threads A, B and C start, the element processor PE0 sets the shared memory 4 such that the synchronization selection information SYNCSEL1 becomes “00010” and the synchronization selection information SYNCSEL2 becomes “00100”, and starts the processing-of the thread A.

Since the synchronization control unit S1 corresponding to the element processor PE1 has asserted the synchronization signal SYNC1, and the synchronization selection information SYNCSEL1 has been set as “00010”, and the synchronization request signal from the element processor PE1 has been asserted, the synchronization permission unit of the synchronization control unit S1 asserts the synchronization permission signal. As a result, the element processor PE1 starts the processing of the thread B.

Immediately after asserting the synchronization permission signal, the synchronization control unit S1 deasserts the synchronization signal SYNC1.

Since the synchronization control unit S2 corresponding to the element processor PE2 has asserted the synchronization signal SYNC2, and the synchronization selection information SYNCSEL2 has been set as “00100”, and the synchronization request signal from the element processor PE2 has been asserted, the synchronization permission unit of the synchronization control unit S2 asserts the synchronization permission signal. As a result, the element processor PE2 starts the processing of the thread C.

Immediately after asserting the synchronization permission signal, the synchronization control unit S2 deasserts the synchronization signal SYNC2.

At the time T3, the element processor PE4 keeps waiting for the synchronization.

<Time T4>

Immediately before the time T4, that is, before the threads D and E start, the element processor PE3 sets the shared memory 4 such that the synchronization selection information SYNCSEL4 becomes “10000”, and starts the processing of the thread D.

Since the synchronization control unit S4 corresponding to the element processor PE4 has asserted the synchronization signal SYNC4, and the synchronization selection information SYNCSEL4 has been set as “10000”, and the synchronization request signal from the element processor PE4 has been asserted, the synchronization permission unit of the synchronization control unit S4 asserts the synchronization permission signal. As a result, the element processor PE4 starts the processing of the thread E.

Immediately after asserting the synchronization permission signal, the synchronization control unit S4 deasserts the synchronization signal SYNC4.

<Time T5>

Before the time T5, the element processor PE0 has completed the processing of the thread A, has set the synchronization selection information SYNCSEL0 to be “00110”, and has asserted the synchronization request signal. At this moment, the value of the synchronization signal SYNC0 has not been changed to a value “1”, but is still “0”. Therefore, the status of the synchronization signal SYNC0 is remained to be the “deassertion”.

Before the time T5, the element processor PE2 also has completed the processing of the thread C, has set the synchronization selection information SYNCSEL2 to be “000000”, and has asserted the synchronization request signal. At this moment, the element processor PE1 sets the value of the synchronization signal SYNC2 to be “1”. Therefore, the synchronization control unit S2 asserts the synchronization signal SYNC2.

Before the time T5, the element processor PE1 has completed the processing of the thread B, has set the synchronization selection information SYNCSEL1 to be “000000”. At the time T5, the element processor PE1 asserts the synchronization request signal. At this moment,the element processor PE1 sets the value of the synchronization signal SYNC1 to be “1”. Therefore, the synchronization control unit S1 asserts the synchronization signal SYNC1.

At the time T5, in accordance with the assertion of the synchronization signals SYNC1 and SYNC2, the synchronization control unit S0 asserts the synchronization permission signal. The element processor PE0 receives the asserted synchronization permission signal, and then starts the processing of the process A.

<Time T6>

Before the time T6, the element processor PE3 has completed the processing of the thread D, has set the synchronization selection information SYNCSEL3 to be “10000”, and has asserted the synchronization request signal. At this moment, the value of the synchronization signal SYNC3 has not been changed to a value “1”, but is still “0”. Therefore, the status of the synchronization signal SYNC3 is remained to be the “deassertion”.

Immediately before the time T6, the element processor PE4 sets the shared memory 4 such that the synchronization selection information SYNCSEL4 becomes “00000”, and at the time T6, asserts the synchronization request signal. At this moment, the element processor PE4 sets the value of the synchronization signal SYNC4 to be “1”. Therefore, the synchronization control unit S4 asserts the synchronization signal SYNC4.

At the time T6, in accordance with the assertion of the synchronization signal SYNC4, the synchronization control unit S3 asserts the synchronization permission signal. The element processor PE3 receives the asserted synchronization permission signal, and then starts the processing of the process B.

<Time T7>

Before the time T7, the element processor PE0 has completed the processing of the process A, has set the synchronization selection information SYNCSEL0 to be “01000”, and has asserted the synchronization request signal. At this moment, the value of the synchronization signal SYNC0 has not been changed to a value “1”, but is still “0”. Therefore, the status of the synchronization signal SYNC0 is remained to be the “deassertion”.

Immediately before the time T7, the element processor PE3 has completed the processing of the process B, has set the synchronization selection information SYNCSEL3 to be “000000”. At the time T7, the element processor PE3 asserts the synchronization request signal. At this moment, the element processor PE3 sets the value of the synchronization signal SYNC3 to be “1”. Therefore, the synchronization control unit S3 asserts the synchronization signal SYNC3.

At the time T7, in accordance with the assertion of the synchronization signal SYNC3, the synchronization control unit S0 asserts the synchronization permission signal. The element processor PE0 receives the asserted synchronization permission signal, and then starts processing of the application.

<Effects>

With use of the multiprocessor system 1 described above, it becomes possible to set the values of the synchronization signals to be transmitted by the synchronization control unit in accordance with the processing to be executed next by the element processor corresponding to the synchronization control unit, without depending on the asserted synchronization request signal indicating that the element processor is actually waiting for the synchronization. Therefore, in the case of executing processing of each layer of the hierarchy, such as the application layer, the process layer and the thread layer in parallel, if the element processor that executes the process layer, such as the element processor PE3, completes the processing of the thread layer, the synchronization control unit S3 corresponding to the element processor PE3 does not assert the synchronization signal till the other element processors complete the processing of the thread layer. Also, when the element processor PE3 completes the processing of the process layer, the synchronization control unit S3 asserts the synchronization signal to notify the element processor PE0 that executes the processing of the application layer of the completion of the processing of the process layer.

As a result, the multiprocessor system 1 can realize hierarchical parallel processing without causing a program that the element processors can not synchronize with each other.

Note that, in the aforementioned multiprocessor system 1, although any of the element processors sets the synchronization selection information before executing the synchronization instruction for asserting the synchronization request signal, a synchronization selection signal field may be prepared in the synchronization instruction, because the values of the synchronization selection information and the synchronization signal are often changed in the same timing.

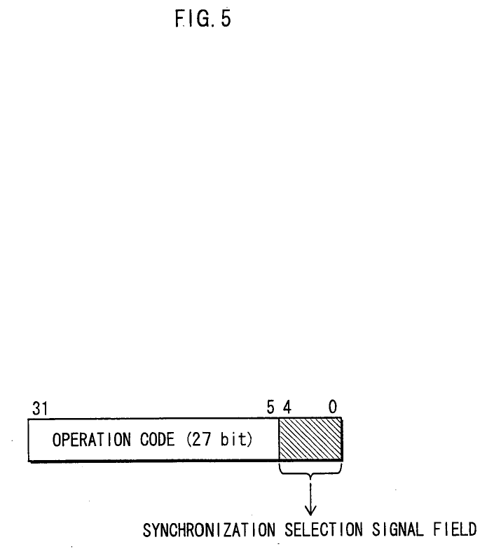

FIG. 5 shows a format of a synchronization instruction including a synchronization selection signal field.

In FIG. 5, the instruction length of the synchronization instruction is 32 bits, and lower five bits are used as the synchronization selection signal field.

When any of the element processors executes such a synchronization instruction, the value in the synchronization selection signal field may be set to the shared memory 4 as the synchronization selection information for the designated synchronization control unit.

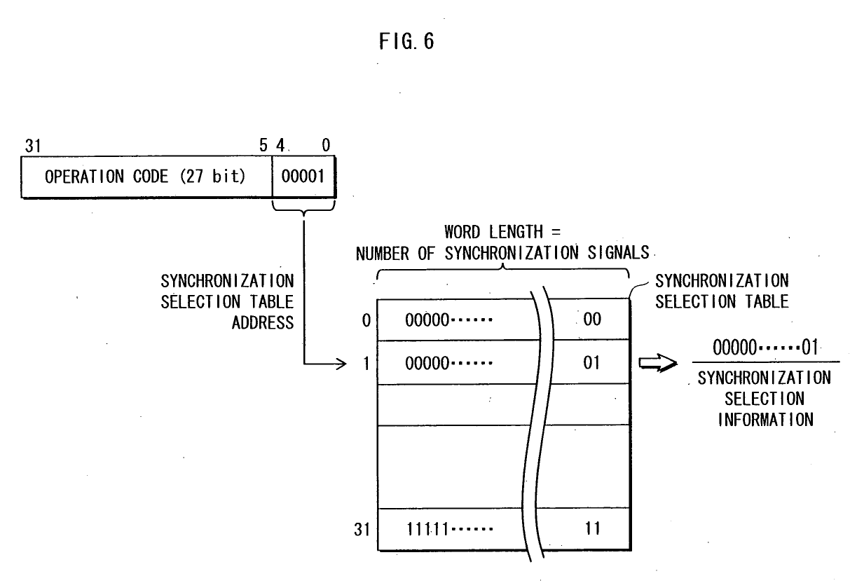

With consideration of the case where five or more element processors are used, lower 10 bits may be used as the synchronization selection signal fields. Moreover, if 32 or more element processors are used the instruction length of the synchronization instruction is not enough for them, a synchronization selection table shown in FIG. 6 having a bit width that is the same as the number of the element processors may be prepared, and the synchronization selection information may be selected by addressing the table by the lower bits of the synchronization instruction.

With regard to element processors not installed with the aforementioned synchronization instruction, a load/store instruction with respect to data memory may be executed by in-order execution. With regard to element processors that are to be interlocked when waiting for memory accesses, the load/store instruction may be used instead of the synchronization instruction. For example, a 32-bit memory space may previously be secured for the synchronization control unit, and a memory request (strobe) of the store instruction as the synchronization request signal, and the store data as the synchronization selection information may be output to the memory space secured for the synchronization control unit. Then, a memory acknowledge may be returned to the element processor as the synchronization permission signal. As a result, the store instruction can work as the synchronization instruction.

### MODIFICATION EXAMPLE 1

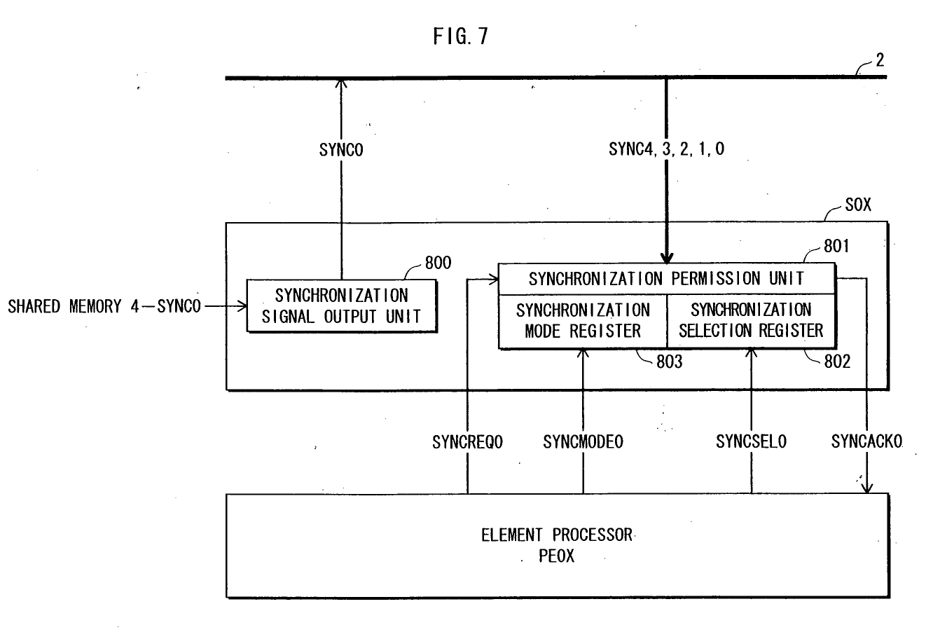

FIG. 7 shows a structure of a synchronization control unit S0X according to a multiprocessor system 1X (not illustrated) according to a modification example 1.

Basically, the multiprocessor system 1X has the same structure as the multiprocessor system 1 shown FIG. 1. However, connections between the element processors PE0X-PE4X and the synchronization control units S0X-S4X are different, and the internal structures of the synchronization control units S0X-S4X are different.

The following describes only the structure of the synchronization control unit S0X as a representative of the synchronization control units S0X-S4X.

### STRUCTURE OF MODIFICATION EXAMPLE 1

The synchronization control unit S0X includes therein a synchronization signal output unit 800, a synchronization permission unit 801, a synchronization selection register 802 and a synchronization mode register 803.

The difference from the aforementioned synchronization control unit S0 is that the value of the synchronization signal SYNC0 written in the shared memory 4 by any of the element processors is input in the synchronization signal output unit 800 connected with a shared bus 2, and that the synchronization selection register 802 and the synchronization mode register 803 are included.

The synchronization signal output unit 800 is connected with the shared bus 3, and the synchronization permission unit 801 is connected with the SYNC0-SYNC4 signal wires (the synchronization bus 2), the SYNCREQ signal wire, and the SYNCACK signal wire.

Also, a SYNCMODE0 signal wire is connected with the synchronization mode register 803, and a SYNCSEL0 signal wire is connected with the synchronization selection register 802.

The value of SYNC0 written in the shared memory by any of the element processors is input in the synchronization signal output unit 800 via the shared bus 2. If the value is 1, the synchronization signal output unit 800 asserts the SYNC0 signal with asserting the signal, and if the value is 0, the synchronization signal output unit 800 outputs the SYNC0 signal with deasserting the signal.

The SYNCREQ signal wire is to be asserted when the element processor PE0 executes the synchronization instruction.

The SYNCMODE0 signal wire is used for notifying the synchronization mode register 803 of the synchronization mode information set by the element processor PE0.

The SYNCSEL0 signal wire is used for notifying the synchronization selection register 802 of the synchronization selection information set by the element processor PE0.

The synchronization permission unit 801 performs logical operations using the synchronization request signal input from the SYNCREQ signal wire, the synchronization signals received from the respective synchronization control units via the SYNC0-SYNC4 signal wires, the synchronization mode information SYNCMODE0 written in the synchronization mode register 803 and the synchronization selection information SYNCSEL0 written in the synchronization selection register 802, to output the synchronization permission signal of 0 (deassertion) or 1 (assertion) to the element processor PE0X via the SYNCACK signal wire.

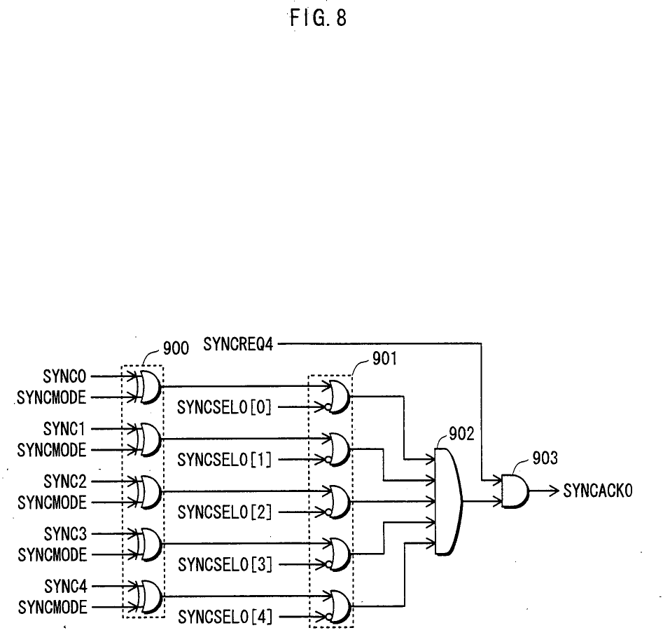

FIG. 8 shows a logical circuit structure of the synchronization permission unit 801.

XOR circuit devices included in a portion 900 surrounded by a dotted line in FIG. 8 respectively receive synchronization signals (SYNC0-SYNC4) from the synchronization control units and the synchronization mode information SYNCMODE0. Then, the exclusive ORs calculated by the XOR circuit devices are respectively input to the OR circuit devices included in a portion 901 surrounded by a dotted line in FIG. 8.

Furthermore, inverted values of the bits (SYNCSEL[0], SYNCSEL[1], SYNCSEL[2], SYNCSEL[3] and SYNCSEL[4]) of the synchronization selection information SYNCSEL0 are input to the respective OR circuit devices.

Then, the results of the logical additions performed by the OR circuit devices are input to a wired AND circuit device 902. The output from the wired AND circuit device 902 and the synchronization request signal are input to an AND circuit device 903. The AND circuit device 903 outputs a result signal to the SYNCACK signal wire.

The following explains the role of the synchronization mode information. The synchronization mode information takes a value 0 or 1. If the synchronization mode information is 0, the synchronization signal passes through the XOR circuit device without change, and if the synchronization mode information is 1, the synchronization signal is inverted when passing through the XOR circuit device.

Therefore, by setting “0” to the synchronization mode information, the synchronization permission signal will be asserted if the synchronization signal corresponding to a bit “1” in the synchronization selection information SYNC0 is 1. On the other hand, by setting “1” to the synchronization mode information, the synchronization permission signal will be asserted if the synchronization signal corresponding to a bit “1” in the synchronization selection information SYNC0 is 0. As a result, the following setting and the likes become available: to see the timing in which the status of the selected synchronization signal changes from the deassertion to the assertion, “0” is set to the synchronization mode information, and to see the timing of the change from the assertion to the deassertion the other way round, “1” is set to the synchronization signal.

### OPERATIONS OF MODIFICATION EXAMPLE 1

The following describes specific operations with reference to a time chart.

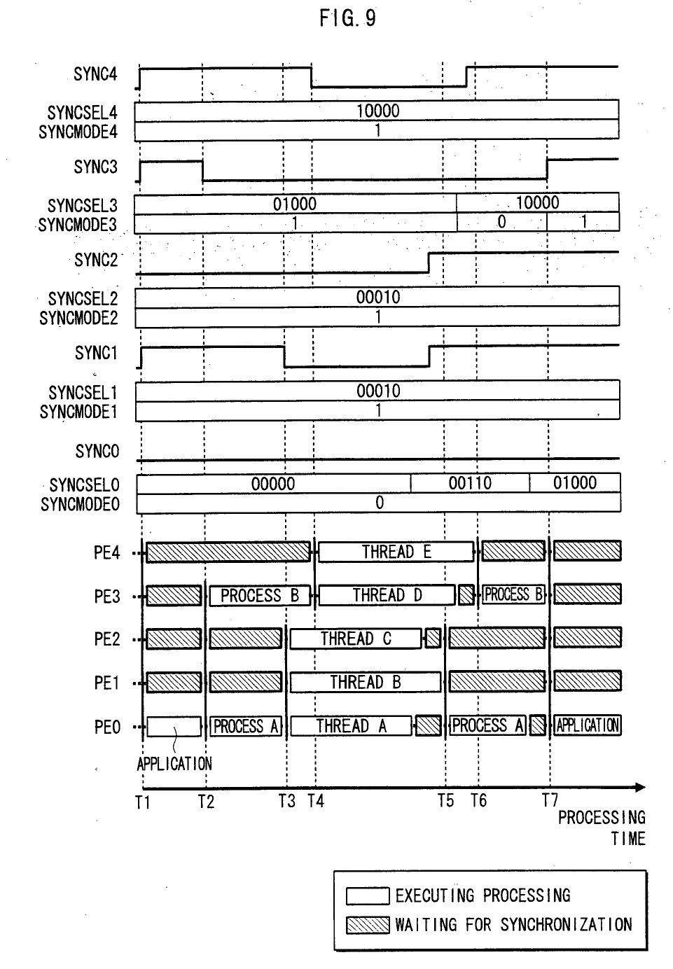

FIG. 9 is a time chart showing the case where the hierarchical parallel processing shown in FIG. 14 is executed by the multiprocessor system 1.

Operations of the element processors PE0X-PE4X and the synchronization control units S0X-S4X are explained as to each of times T1-T7 shown in FIG. 9.

<Time T1>

The element processor PE0X starts processing of the application from the time T1. Then, the element processor PE0X sets the shared memory 4 such that the synchronization signal SYNC0 becomes 0, the synchronization signal SYNC1 becomes 1, the synchronization signal SYNC2 becomes 0, the synchronization signal SYNC3 becomes 1 and the synchronization signal SYNC4 becomes 1, and sets the synchronization selection register of the synchronization control unit S0X corresponding to the PE0X such that the synchronization selection information SYNCSEL0 becomes “00000”, and sets the synchronization mode register such that synchronization mode information becomes 0.

At the time T1, the element processor PELX sets “00010” as the synchronization selection information to the synchronization selection register of the synchronization control unit S1X corresponding to the element processor PE1X, sets 1 as the synchronization mode information to the synchronization mode register, and asserts the synchronization request signal.

At the time T1, the element processor PE2X sets “00010” as the synchronization selection information to the synchronization selection register of the synchronization control unit S2X corresponding to the element processor PE2X, sets 1 as the synchronization mode information to the synchronization mode register, and asserts the synchronization request signal.

At the time T1, the element processor PE3X sets “01000” as the synchronization selection information to the synchronization selection register of the synchronization control unit S3X corresponding to the element processor PE3X, sets 1 as the synchronization mode information to the synchronization mode register, and asserts the synchronization request signal.

At the time T1, the element processor PE4X sets “10000” as the synchronization selection information to the synchronization selection register of the synchronization control unit S4X corresponding to the element processor PE4X, sets 1 as the synchronization mode information to the synchronization mode register, and asserts the synchronization request signal.

Since a value “0” of SYNC0 is input to the synchronization signal output unit, the synchronization control unit S0X deasserts the synchronization signal SYNC0.

Since a value “1” of SYNC1 is input to the synchronization signal output unit, the synchronization control unit S1X asserts the synchronization signal SYNC1.

Since a value “0” of SYNC2 is input to the synchronization signal output unit, the synchronization control unit S2X deasserts the synchronization signal SYNC2.

Since a value “1” of SYNC3 is input to the synchronization signal output unit, the synchronization control unit S3X asserts the synchronization signal SYNC3.

Since a value “1” of SYNC4 is input to the synchronization signal output unit, the synchronization control unit S4X asserts the synchronization signal SYNC4.

Since a value “0” is set to the synchronization mode register, the synchronization control unit S0X does not assert the synchronization permission signal until the synchronization signal as a selection target set to the synchronization selection register is asserted (1).

Since a value “1” is set to the synchronization mode register, each of the synchronization control units S1X-S4X does not assert the synchronization permission signal until the synchronization signal as a selection target set to the synchronization selection register is deasserted (0).

<Time T2>

At the time T2, the element processor PE0X sets the shared memory 4 such that the synchronization signal SYNC3 becomes 0, and starts the processing of the process A.

The synchronization signal output unit of the synchronization control unit S3X deasserts the synchronization signal SYNC3 in accordance with the value 0 of the synchronization signal SYNC3 input via the shared bus 2. Upon receiving the deasserted synchronization signal SYNC3, the synchronization permission unit of the synchronization control unit S3X asserts the synchronization permission signal.

As a result, the element processor PE3X starts the processing of the process B.

At the time T2, the element processors PE1, PE2 and PE4 keep waiting for the synchronization.

<Time T3>

At the time T3, the element processor PE0 sets the shared memory 4 such that the value of the synchronization signal SYNC1 becomes 0, and starts the processing of the thread A.

The synchronization signal output unit of the synchronization control unit S1X deasserts the synchronization signal SYNC1 in accordance with the value 0 of the synchronization signal SYNC1 input via the shared bus 2. Upon receiving the deasserted synchronization signal SYNC1, the synchronization permission units of the synchronization control unit S1X and S2X respectively assert the synchronization permission signal.

As a result, the element processor PE1X starts the processing of the thread B and the element processor PE2X starts the processing of the thread C.

At the time T3, the element processor PE4 keeps waiting for the synchronization.

<T4>

At the time T4, the element processor PE3X sets the shared memory 4 such that the value of the synchronization signal SYNC4 becomes 0, and starts the processing of the thread D.

The synchronization signal output unit of the synchronization control unit S4X deasserts the synchronization signal SYNC4 in accordance with the value 0 of the synchronization signal SYNC4 input via the shared bus 2. Upon receiving the deasserted synchronization signal SYNC4, the synchronization permission units of the synchronization control unit S4X asserts the synchronization permission signal.

As a result, the element processor PE4X starts the processing of the thread E.

<Time T5>

Before the time T5, the element processor PE0X has completed the processing of the thread A, has set the synchronization selection information SYNCSEL0 to be “00110”, and has asserted the synchronization request signal. At this moment, the value of the synchronization signal SYNC0 has not been changed to a value “1”, but is still “0”. Therefore, the status of the synchronization signal SYNC0 is remained to be the “deassertion”.

Before the time T5, the element processor PE2X also has completed the processing of the thread C, and has asserted the synchronization request signal. At this moment, the element processor PE2X sets the shared memory 2 such that the synchronization signal SYNC2 becomes 1. Therefore, the synchronization control unit S2X asserts the synchronization signal SYNC2.

At the time T5, the element processor PELX completes the processing of the thread B, and asserts the synchronization request signal. At this moment, the element processor PELX sets the shared memory 2 such that the synchronization signal SYNC1 becomes 1. Therefore, the synchronization control unit S1X asserts the synchronization signal SYNC1.

At the time T5, in accordance with the assertion of the synchronization signals SYNC1 and SYNC2, the synchronization control unit S0X asserts the synchronization permission signal. The element processor PE0X receives the asserted synchronization permission signal, and then starts the processing of the process A

<Time T6>

Before the time T6, the element processor PE3X has completed the processing of the thread D and has asserted the synchronization request signal. At this moment, the value of the synchronization signal SYNC3 has not been changed to a value “1”, but is still “0”. Therefore, the status of the synchronization signal SYNC3 is remained to be the “deassertion”.

At the time T6, the element processor PE4X completes the processing of the thread E, and asserts the synchronization request signal. At this moment, the element processor PE4X sets the shared memory 2 such that the synchronization signal SYNC4 becomes 1. Therefore, the synchronization control unit S4X asserts the synchronization signal SYNC4.

At the time T6, in accordance with the assertion of the synchronization signals SYNC4, the synchronization control unit S3X asserts the synchronization permission signal. The element processor PE3X receives the asserted synchronization permission signal, and then starts the processing of the process B.

<Time T7>

Before the time T6, the element processor PE0X has completed the processing of the process A and has asserted the synchronization request signal. At this moment, the value of the synchronization signal SYNC0 has not been changed to a value “1”, but is still “0”. Therefore, the status of the synchronization signal SYNC0 is remained to be the “deassertion”.

At the time T7, the element processor PE3X completes the processing of the process B, and asserts the synchronization request signal. At this moment, the element processor PE3X sets the shared memory 2 such that the synchronization signal SYNC3 becomes 1. Therefore, the synchronization control unit S3X asserts the synchronization signal SYNC3.

At the time T7, in accordance with the assertion of the synchronization signal SYNC3, the synchronization control unit S0X asserts the synchronization permission signal. The element processor PE0X receives the asserted synchronization permission signal, and then starts the processing of the application.

### EFFECTS OF THE MODIFICATION EXAMPLE 1

With the multiprocessor system 1X, frequency of use of the shared memory 4 and the shared bus 2 for controlling the synchronization can be significantly reduced compared to the multiprocessor system 1. Therefore, it is expected that overhead, which can be caused in the case where the number of the element processors is increased, is suppressed.

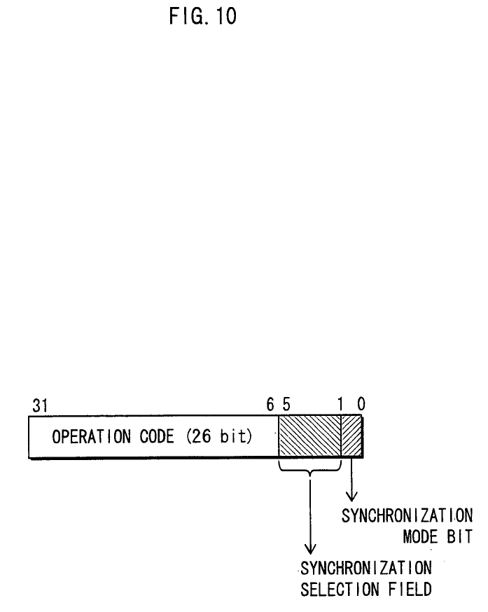

As the synchronization instruction, an instruction format shown in FIG. 10, including a synchronization selection field and a synchronization mode bit, may be used.

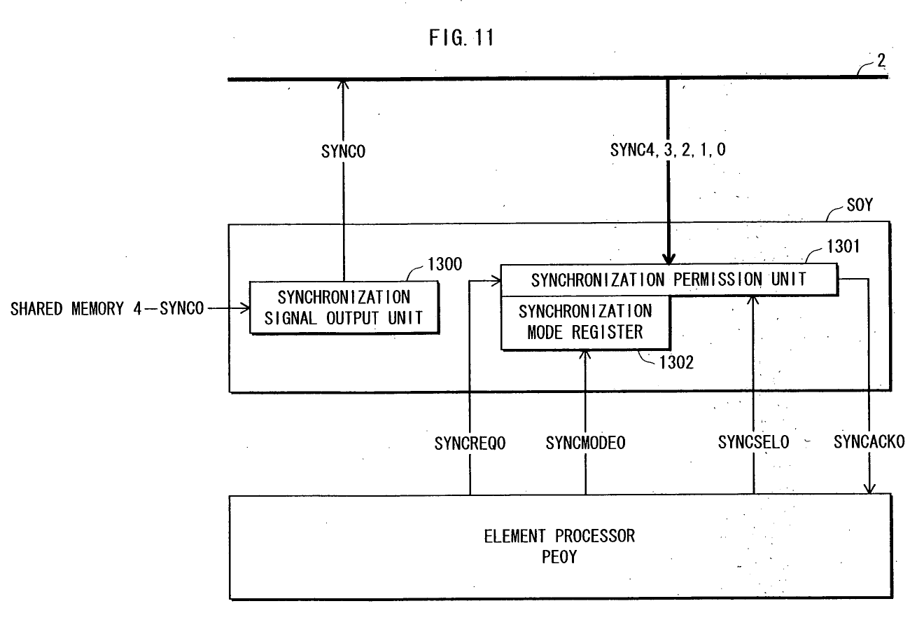

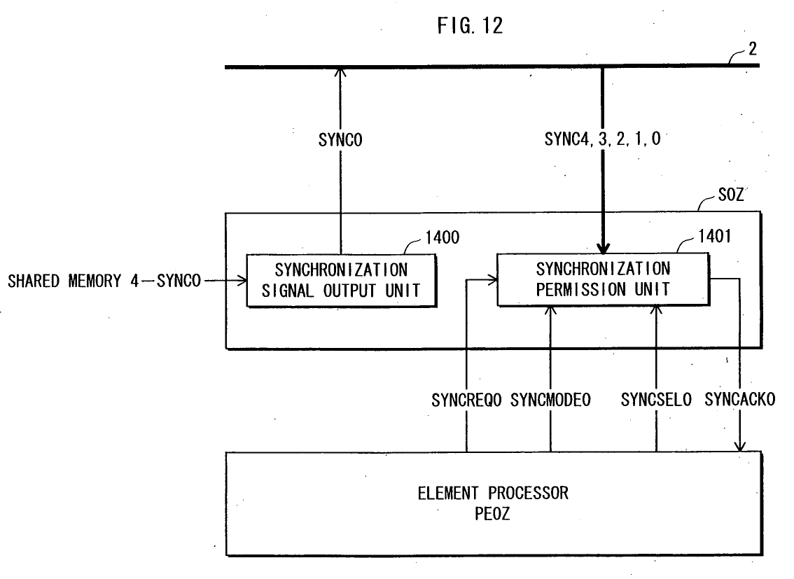

Moreover, a synchronization control unit having the structure shown in FIG. 11 and FIG. 12 may be-used.

### MODIFICATION EXAMPLE 2

FIG. 11 shows a structure of a synchronization control unit S0Y of a multiprocessor system 1Y (not illustrated) according to a modification example 2.

Basically, the multiprocessor system 1Y has the same structure as the multiprocessor system 1X and performs the same operations as the multiprocessor system 1X. However, connections between the element processors PE0Y-PE4Y and the synchronization control units S0Y-S4Y are different, and the internal structures of the synchronization control units S0Y-S4Y are different.

The following describes only the structure of the synchronization control unit S0Y as a representative of the synchronization control units S0Y-S4Y.

The synchronization control unit S0Y includes therein a synchronization signal output unit 1300, a synchronization permission unit 1301, and a synchronization mode register 1302.

The difference from the aforementioned synchronization control unit S0X is that the synchronization selection register 802 is not included.

The SYNCSEL0 signal wire is used for notifying the synchronization permission unit 1301 of the synchronization selection information set by the element processor PE0Y.

The synchronization permission unit 1301 performs logical operations using the synchronization request signal input from the SYNCREQ signal wire, the synchronization signals received from the respective synchronization control units via the SYNC0-SYNC4 signal wires, the synchronization mode information SYNCMODE0 written in the synchronization mode register 1303 and the synchronization selection information SYNCSEL0 directly notified from the element processor PE0Y, to output the synchronization permission signal of 0 (deassertion) or 1 (assertion) to the element processor PE0Y via the SYNCACK signal wire.

### MODIFICATION EXAMPLE 3

FIG. 12 shows a structure of a synchronization control unit S0Z of a multiprocessor system 1Z (not illustrated) according to a modification example 3.

Basically, the multiprocessor system 1Y has the same structure as the multiprocessor system 1X and performs the same operations as the multiprocessor system 1X. However, connections between the element processors PE0Z-PE4Z and the synchronization control units S0Z-S4Z are different, and the internal structures of the synchronization control units S0Z-S4Z are different.

The following describes only the structure of the synchronization control unit S0Z as a representative of the synchronization control units S0Z-S4Z.

The synchronization control unit S0Z includes therein a synchronization signal output unit 1400 and a synchronization permission unit 1401.

The difference from the aforementioned synchronization control unit S0X is that the synchronization selection register 802 and the synchronization mode register 803 are not included.

The SYNCSEL0 signal wire is used for notifying the synchronization permission unit 1401 of the synchronization selection information set by the element processor PE0Z.

The SYNCMODE0 signal wire is used for notifying the synchronization permission unit 1401 of the synchronization mode information set by the element processor PE0Z.

The synchronization permission unit 1401 performs logical operations using the synchronization request signal input from the SYNCREQ signal wire, the synchronization signals received from the respective synchronization control units via the SYNC0-SYNC4 signal wires, the synchronization mode information SYNCMODE0 and the synchronization selection information SYNCSEL0 directly notified from the element processor PE0Z, to output the synchronization permission signal of 0 (deassertion) or 1 (assertion) to the element processor PE0Z via the SYNCACK signal wire.

### INDUSTRIAL APPLICABILITY

The present invention is effective for a multiprocessor system that performs parallel processing.

1. A multiprocessor system that includes a plurality of element processors and a plurality of synchronization control units respectively corresponding thereto, wherein
each of the element processors comprises:
a setting unit operable to set, to any of the synchronization control units, a value of a synchronization signal to be transmitted by the any of the synchronization control units and synchronization selection information to be used for selecting any of received synchronization signals, in accordance with processing to be executed next by one of the element processors that corresponds to the any of the synchronization control units; and
an output unit operable to output a synchronization request signal to one of the synchronization control units that corresponds thereto before execution of processing that requires synchronization with another one or more of the element processors, to pause the execution of the processing until a synchronization permission signal is input from the one of the synchronization control units, and
the synchronization control units
are connected together for receiving and transmitting the synchronization signal from and to each other, and
each comprises a synchronization permission unit operable to output a synchronization permission signal to one of the element processors that corresponds thereto if the synchronization request signal has been input from the one of the element processors and all of synchronization signals selected based on the synchronization selection information set by the any of the element processors indicate a prescribed value.

2. The multiprocessor system of claim 1, further including
a shared memory that is accessible from each of the element processors and each of the synchronization control units, on which are mapped areas for storing synchronization selection information for each of the synchronization control units, wherein
each of the synchronization control units further comprises a synchronization register connected with corresponding one of the element processors by a dedicated line, and
each of the element processors sets the value of the synchronization signal to the synchronization register in accordance with the processing to be executed next.

3. The multiprocessor system of claim 1, wherein
each of the element processors further comprises an execution unit operable to execute a synchronization instruction including information specifying the synchronization selection information, and
the execution unit causes the output unit to output the synchronization request signal to the corresponding one of the synchronization control units, and causes the setting unit to set the synchronization selection information to one of the synchronization control units that is specified by the synchronization instruction.

4. The multiprocessor system of claim 1, wherein
the setting unit further sets synchronization mode information for determining the prescribed value to the any of the synchronization control units, and
the synchronization permission unit outputs the synchronization permission signal if the synchronization request signal has been input from the one of the element processors and all of the synchronization signals selected based on the synchronization selection information indicate the prescribed value that is determined based on the synchronization mode information.

5. The multiprocessor system of claim 4., further including
a shared memory that is accessible from each of the element processors and each of the synchronization control units, on which are mapped areas for storing synchronization selection information for each of the synchronization control units, wherein
each of the synchronization control units further comprises a synchronization register connected with corresponding one of the element processors by a dedicated line, and a synchronization mode register, and
each of the element processors sets the value of the synchronization signal to the synchronization register in accordance with a value of one of the synchronization signals, and sets the synchronization mode information to the synchronization mode register corresponding thereto.

6. The multiprocessor system of claim 4, wherein
each of the element processors further comprises an execution unit operable to execute a synchronization instruction including information specifying the synchronization selection information and the synchronization mode information, and
the execution unit causes the output unit to output the synchronization request signal to the corresponding one of the synchronization control units, and causes the setting unit to set the synchronization selection information and the synchronization mode information to one of the synchronization control units that is specified by the synchronization instruction.

7. Synchronization control apparatuses that are provided in a multiprocessor system and respectively correspond to element processors included in the multiprocessor system, each comprising
a transmission unit operable to transmit a synchronization signal indicating a value set by any of the element processors to another one or more of the synchronization control apparatuses;
a reception unit operable to receive the synchronization signal from the one or more of the synchronization control apparatuses; and
a synchronization permission unit operable to output a synchronization permission signal to one of the element processors that corresponds thereto if a synchronization request signal has been input from the one of the element processors and all of synchronization signals selected based on the synchronization selection information set by the any of the element processors indicate a prescribed value.

8. A synchronization control method used in a multiprocessor system that includes a plurality of element processors and a plurality of synchronization control units respectively corresponding thereto, comprising:
the steps performed by each element processors of
setting, to any of the synchronization control units, a value of a synchronization signal to be transmitted by the any of the synchronization control units and synchronization selection information to be used for selecting any of received synchronization signals, in accordance with processing to be executed next by one of the element processors that corresponds to the any of the synchronization control units; and
outputting a synchronization request signal to one of the synchronization control units that corresponds thereto before execution of processing that requires synchronization with another one or more of the element processors, to pause the execution of the processing until a synchronization permission signal is input from the one of the synchronization control units, and
the step performed by each of the synchronization control units that are connected for receiving and transmitting the synchronization signal from and to each other of
outputting a synchronization permission signal to one of the element processors that corresponds thereto if the synchronization request signal has been input from the one of the element processors and all of synchronization signals selected based on the synchronization selection information set by the any of the element processors indicate a prescribed value.
